(19) United States
(12) Patent Application Publication
(10) Pub. No.: US 2004/0199873 A1
(43) Pub. Date: Oct. 7, 2004

(54) Method and system of playing, editing and recording object-behaviors of digital content

(75) Inventors: Jen-Hwang Weng, Jungli City (TW); Jung-Sheng Lin, Kaohsiung (TW); Shu-Chun Liu, Jungli City (TW); Ching-Mao Yeh, Miaoli (TW)

Correspondence Address: BRUCE H. TROXELL, SUITE 1404, 5205 LEESBURG PIKE, FALLS CHURCH, VA, 22041, US

(73) Assignee: Jen-Hwang WENG

(21) Appl. No.: 10/816,044

(22) Filed: Apr. 2, 2004

(30) Foreign Application Priority Data
Apr. 4, 2003 (TW) 92107690

(51) Int. Cl. G06F 17/21

(52) U.S. Cl. 715/515

(57) ABSTRACT

A website system is used for manipulating a digital content in a client computer. The digital content comprises a plurality of object-behaviors. The website system at least comprises a communication interface, a memory and a behavior playing mechanism. The communication interface is used for setting up a communication link with the client computer. The memory is used for storing the digital content and a behavior sequence which is an order of the object-behaviors being triggered. The digital content and the behavior sequence are downloaded to the client computer via the communication link through the communication interface. The behavior playing mechanism which is downloaded to the client computer via the communication link through the communication interface is used for triggering the object-brhaviors in a proper order based on the behavior sequence.

### BACKGROUND OF THE INVENTION

1. Field of the Invention

This present invention relates to a system for playing, editing or recording object-behaviors in a digital content, and a method therefore. Said system and method are able to play the object-behaviors in a proper order, and to record or to edit the order of the object-behavior being triggered.

A digital content is mostly manipulated by a user via an input device, such as a mouse, a keypad, a rocker, a photo pen or a voice input software etc. To make an object into a digital content, the object usually comprises an event, a method and a property. The user can use the input device to drive the method of the object, to change the property value of the object, or to trigger the event of the object so as to achieve the goal of manipulating the digital content. In the art, the digital content is preferably to interact with the user in real time. The user can input his/her request to the digital content by any appropriate input device, and the digital content, on the other hand, would respond the request by triggering the event, driving the method or changing the property value.

As described above, when the user manipulate the digital content with a particular objective, the user have to trigger the behaviors of the objects in the digital content in a proper order. If we saved the order of the object-behaviors being triggered with a time sequence, then we can replay the manipulation play-by-play by playing the order we recorded. If the order we recorded relates to the instruction of the digital content, playing the order would help to teach a beginner to manipulate the digital content. Moreover, adding the voice instruction will help the beginner to understand how to manipulate the digital content.

2. Description of the Prior Art

The prior art for recording the manipulation of the digital content is to record the images during manipulation, and the prior art replays the manipulation as a video. For example, the prior art records how to use a mouse to drive a digital content and plays the recorded images to reproduce the manipulation play-by-play. The recorded images comprise the image of the mouse and the image of the moving mouse, but the mouse in the recorded images doesn't truly trigger the object-behavior. When the user stops playing the recorded images, the user can't use the mouse to manipulate the digital content. To wit, the environment for manipulating the digital content is different to the environment for playing the manipulation, so the user can't practice the detail manipulation even stop playing the recording images.

Besides, there is a prior art which reproduces the manipulation by installing a driver program in the user's computer. The driver program can drive the mouse of the user's computer to reproduce the manipulation play-by-play. In common, Installing driver program will cause some problems, so the user won't accept this method. On one hand, the user disinclines to install the unknown program to protect his/her computer; on the other hand, any wrong image would cause the wrong reproducing. That's because the recorded images are location of the mouse and moving of the mouse. If the real location of the mouse is different to that in the recorded image, it would cause the driver program unable to drive the designed object-behavior. Moreover, the prior art just applies in one input device; if the environment comprises other input devices, the prior art couldn't reproduce all of the manipulation play-by-play.

### SUMMARY OF THE INVENTION

The primary object of this present invention is to reproduce the manipulation of the digital content play-by-play. The present invention is able to let the user to manipulate the digital content when stop reproducing the manipulation in the same environment. Besides, the present invention is to trigger the object-behaviors as the object-behaviors being triggered before, so the present invention doesn't have to care the location of the object but can trigger the object-behavior accurately.

Because the mechanism contained in the digital content always connect the different objects by the different event to act a proper response. Whether drive the method of the object, change the property value of the object, or trigger the event of the object, there will always use event to acquaint the other object or the user. Then the user or the other object being acquainted could properly response the event. Thus, the present invention could realize what object-behavior being triggered by the event being triggered in the digital content. The present invention records the object-behaviors, which are triggered with time variation, as a behavior sequence. By this way, when playing the behavior sequence, the present invention can truly trigger each object-behavior in a proper order in the original environment. For example, when the user changes the digital content by using the input device, the displayed result of digital content being change is an accumulation of the user using the input device to trigger the object-behaviors in a proper order. In this manner, the user can arbitrarily stops playing the reproduction of the order of the object-behaviors being triggered, and where the user stop playing is the accumulation of the user using the input device to trigger the object-behaviors. In another word, the initial condition of the user proceeding manipulation from the where user stop is the same with the final conditions of the object-behaviors being stop. As the user keeps on manipulating the digital content, the digital content accumulates the effects of the object-behaviors being triggered from where the user stop.

The present invention to let the user keep on manipulating from where user stop can be utilize broadly. For example, a digital content for withdrawing money, when the user wants to withdraw money but the savings are not enough, the present invention could let the user keep on manipulate the digital content, not to finish withdrawing money as prior art. That is to say, applying the present invention, not only can display the manipulation play-by-play, but also won't distort the condition of the manipulation. For another example, a digital content of PC game, the user can save the whole object-behaviors being triggered before the user failure as a behavior sequence, and plays the behavior sequence to find out the reasons of the failure. When finds out the reason, the user could stop playing the behavior sequence and restart from where the user stop playing. Because the object-behaviors before where the user stop are all triggered in a proper order, the manipulation conditions after where the user stop won't be distort.

Moreover, we all knows that the physical phenomenon simulated by simulation software is an accumulation result of the events being triggered. If a researcher wants to reconstruct the physical phenomenon, the conventional simulation software just redisplays the picture of the physical phenomenon but not shows the physical mechanism. Applying the present invention to reconstruct the physical, the user not only can get the pictures of each steps of the physical, but also can get the physical conditions of each step. So the user can easily decide to just watch or keep on simulating.

When talking about studying, if the user has to waste time to study the portion had studied, the user should feel very boring. Applying the present invention, the user can record the object-behaviors being triggered during the studying as a behavior sequence, and the user can play the behavior sequence to review the study process. If there are any losses in the study process, the user could stop playing the behavior sequence and restudy from where the user stops.

In short, if a user wants to restart a digital content, the present invention could let the user to play the behavior sequence and the user could stop playing the behavior sequence and restart to trigger the object-behavior from where the user stop. Such as a software program, the software program comprises a plurality of objects, and visible objects of the objects allow the user to control by the input devices to provide special functions. The behavior sequence of the present invention is the history of the object-behaviors being triggered during demonstrating the software. So to play the behavior sequence can concretely reproduce the manipulation play-by-play, and the user can keep on manipulating the software after playing the behavior sequence or from where the user stop playing the behavior sequence.

Besides, the present invention can also apply in an animation. The characters in the animation are manufactured by Object-Oriented Programming (the character has behaviors such as method, property or event etc., and the user can trigger part of the behaviors of the character by using the input device.). The user can arrange each character to edit a behavior sequence of the animation. Then playing the user-edited behavior sequence could display the effect of the animation and the user could change the animation anytime by using the input device. By this way, the user just need to arrange each character to edit the behavior sequence and then can complete making the animation. If the user wants to design an identical character in different animations, the user shouldn't need to draw the character again, the user just duplicates the behavior sequence of the character into another animation.

One aspect of the present invention is to paly, edit, and record the history of the object-behaviors being triggered in the digital content. The manipulation method of the aspect comprises the following steps:

1. Providing a digital content to a client computer. The digital content at least comprises an object. The object has an identification data and at least comprises a behavior. The user triggers the behavior of the object by an input device.

2. Providing a behavior sequence to a client computer. The behavior sequence is the history of the behaviors of the objects being triggered. The behavior sequence at least comprises the identification data of the object, the relating data of the behavior, and the time of the behavior being triggered.

3. Providing a behavior playing mechanism to the client computer. The behavior playing mechanism triggers the behaviors of the objects according to the behavior sequence.

The digital content could be a webpage, an instruction document, a computer animation, a computer game, and a software etc. The digital content comprises a plurality of objects. The behavior of the object could be a method, a property, and an event. In one of the aspects, the digital content is a webpage and the webpage comprises a button object. The button object has an identification data—btn1. The button object comprises at least a click behavior. The click behavior is an object-method. The user can use the mouse to click the button object.

The behavior sequence is the history of the behavior (click) of the object (btn1) being triggered. The content of the behavior sequence at least comprises the identification data of the object, the relating data of the behavior, and the time of the behavior being triggered. The content of the behavior sequence can be made by not only recording the object-behaviors triggered by the input devices but also editing the object identification data, the object-behavior relating data, and time of object-behavior being triggered. The object-behavior relating data comprises the name of the behavior and the relating parameters of the behavior. If the behavior is a method or an event, the relating data of the behavior would comprise the name of the method or the event. If the behavior is the property, the relating data of the behavior would comprise the name of the property and the property value of the property. In one of the aspects, the behavior sequence comprises three values: btn1, click, and Time1. Each of the value represents the identification data of the object, the name of the behavior, and the time of the behavior being trigger. In another word, this behavior sequence shows that “btn1” is “clicked” at “Time1”. If the “btn1” is clicked N times at N different time, the behavior sequence would comprise N data to represent this situation.

The behavior playing sequence is also configured a counter to trigger the object-behavior in a proper order according to the trigger time listed in the behavior sequence.

The method of the present invention also comprises to provide a visible indicating object to the client computer. The visible indicating object can indicate the object being triggered when the behavior playing mechanism triggers the object-behavior. The objective of the visible indicating object is to clearly indicating the object being triggered, so no matter what appearance of the visible indicating object would be accepted. In one of the aspects, the visible indicating object is a mouse icon. When the behavior playing mechanism triggers the “btn1” to be “clicked” at the “Time1”, the mouse icon indicates the location of the “btn1” at the “Time1”. Besides, when the visible indicating object changes the appearance to correspond to the object-behavior, the visible indicating object also indicates the object-behavior being triggered at the same time. As the above aspect, the visible indicating object indicates the “btn1”, and then the visible indicating object would change appearance to show a “click” action.

The method of the present invention comprises to provide a voice data and a voice playing mechanism to the client computer. The voice data is made during the object-behaviors being triggered and relates to the object-behavior. The voice playing mechanism plays the voice data when the behavior playing mechanism triggers the related object-behavior.

The method of the present invention comprises to provide a behavior editing mechanism. The behavior editing mechanism could use to edit the behavior sequence which is recorded by the user and comprises the identification data of the object, the relating data of the behavior, and the time of the behavior being triggered. The behavior editing mechanism also can be used to edit a triggered history of an object-behavior. To play the triggered history of the object-behavior would get the effect the user wanted.

In one of the aspects, the object-behavior is a method and the digital content further comprises an event. If the user triggers the method, then would further trigger the event. In this aspect, the method of the present invention also comprises to providing a behavior recording mechanism to the client computer. The behavior recording mechanism can record the behavior sequence of the event being triggered. In this aspect, “click” is the method of the button object and “onclick” is the triggering event when drive the “click” method. The behavior sequence comprises three values: btn1, click, and Time1. Each of the value represents the identification data of the object, the name of the method, and the time of the method being trigger. But the name of the method is derived from the triggered event, in this aspect, the triggered event is “onclick” and the triggered method is “click”.

In another aspect, the object-behavior is a property and the digital content further comprises an event. If the user triggers to change the property value, then would further trigger the event. In this aspect, the method of the present invention also comprises to providing a behavior recording mechanism to the client computer. The behavior recording mechanism can record the behavior sequence of the event being triggered. In this aspect, the digital content is the webpage; the object is the “TEXT”. The soure code of the object is:

<INPUT TYPE=“text” NAME=“text1”>

The “value” is the property of the object. To change the “value” will trigger the “onchange” event. If the property value being changed is “Cvalue”, the behavior sequence would at least comprise three values: text1, value/Cvalue, and Time1. Each of the value represents the identification data of the object, the name of the property/the change value of the property, and the time of the property being changed. But the name of the property and the changed value of the property are derived from the triggered event, in this aspect, the triggered event is “onchange”, the name of the changed property is “value”, and the changed value of the change property is “Cvalue”.

In one of the aspects, the object-behavior is an event and the method of the present invention also comprises to providing a behavior recording mechanism to the client computer. The behavior recording mechanism can record the behavior sequence of the event being triggered. In this aspect, “onmouseover” is the triggering event of the digital content. The behavior sequence comprises three values: btn1, onmouseover, and Time1. Each of the value represents the identification data of the object, the name of the event, and the time of the event being trigger. But the name of the method is derived from the triggered event, in this aspect, the triggered event is “onclick” and the triggered method is “click”.

The advantage and spirit of the invention may be understood by the following recitations together with the appended drawings.

### BRIEF DESCRIPTION OF THE APPENDED DRAWINGS

FIG. 1 shows schematically an environment of a typical website system in accordance with the present invention; and

FIG. 2 shows schematically a typical website system in accordance with the present invention.

### DETAILED DESCRIPTION OF THE INVENTION

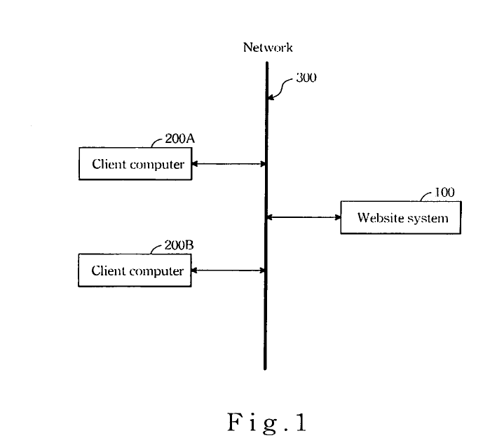

Applying the present invention to network instruction is one embodiment of the present invention. The instruction comprises a plurality of web objects. The teacher can utilize the web browser as an interface to make a behavior sequence of the objects relating to the instruction. The teacher further can also make a voice instruction about the behavior sequence. The students also can utilize the web browser as the interface to play the behavior sequence and the voice instruction to study the network instruction on-line. FIG. 1 shows schematically an environment of a typical website system in accordance with the present invention. FIG. 1 shows that there are pluralities of client computers 200A, 200B can login into the website system 100 via the network 300, and each user won't interference to the other.

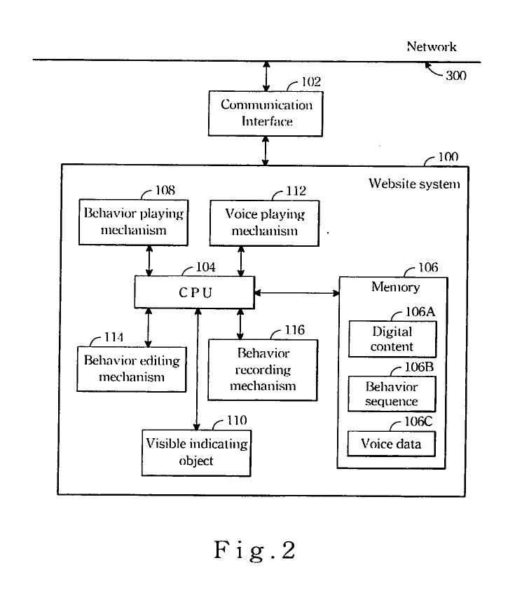

FIG. 2 shows schematically a typical website system in accordance with the present invention. The website system 100 is able to play the object-behaviors in a proper order and to record or to edit the order of the object-behavior being triggered. The website system 100 comprises a communication interface 102, a CPU 104, a memory 106, and a behavior playing mechanism 108. The manipulation of the website system 100 can be described term by term as follows.

The communication interface 102 is used for setting up a communication link, such as an Internet with client computer.

The CPU 104 is used for presenting the content of web page and executing calculations among various mechanisms.

The memory 106 is used for at least saving a digital content 106A and a behavior sequence 106B. The digital content 106A is downloaded to a client computer 200A via a communication link through the communication interface 102. The digital content 106A can comprise at least an object. The object can comprise at least a behavior. The client computer 200A can trigger the object-behavior by using the input device. The behavior sequence 106B is also downloaded to the client computer 200A via the communication link through the communication interface 102.

The behavior playing mechanism 108 is downloaded to the client computer via the communication link through the communication interface 102. The behavior playing mechanism 108 triggers the behaviors of the objects according to the behavior sequence. The object-behavior could be a method, a property, and an event. In one of the embodiments, the digital content is a webpage and the webpage comprises a plurality of web-objects. Let the name of the web-object is ObjID. Let the name of the object-method is ObjMethod. Let the name of the object-property is ObjProperty. Let the name of the changed property value is PropValue. And let the name of the object-event is ObjEveent. The triggering process of the object-behaviors in the webpage is as following:

Drive the object-method: ObjID.ObjMethod( )

Change the object-property: ObjID.ObjProperty=PropValue

Trigger the object-event: ObjID_ObjEvent

The behavior playing mechanism is also configured a counter to trigger the object-behavior in a proper order according to the trigger time listed in the behavior sequence.

The website system 100 of the present invention also comprises a visible indicating object 110. The visible indicating object 110 is downloaded to a client computer 200A via a communication link through the communication interface 102. The visible indicating object 110 can indicate the object being triggered when the behavior playing mechanism 108 triggers the object-behavior. The objective of the visible indicating object 110 is to clearly indicating the object being triggered, so no matter what appearance of the visible indicating object would be accepted. In one of the embodiments, the visible indicating object is a mouse icon. When the behavior playing mechanism 108 triggers the “ObjID” to be “clicked” at the “Time1”, the mouse icon indicates the location of the “ObjID” at the “Time1”. Let the identification of the mouse icon is “cussorIMG”, the website system use the following program to move the mouse icon to the location of the “ObjID” at the time “Time1”.

cussorIMG.left=ObjID.left

cussorIMG.right=ObjID.right

Besides, when the visible indicating object 110 changes the appearance to correspond to the object-behavior, the visible indicating object 110 also indicates the object-behavior being triggered at the same time. As the above embodiment, the visible indicating object 110 indicates the “ObjID”, and then the visible indicating object 110 would change appearance to show a “click” action.

The website system 100 of the present invention also comprises a voice playing mechanism 112. The memory 106 further comprises a voice data 106C. The voice playing mechanism 112 and the voice data 106C are downloaded to a client computer 200A via a communication link through the communication interface 102. The voice data 106C is made during the object-behaviors being triggered and relates to the object-behavior. The voice playing mechanism 112 plays the voice data when the behavior playing mechanism 108 triggers the related object-behavior.

The website system 100 of the present invention also comprises a behavior editing mechanism 114. The behavior editing mechanism 114 is downloaded to a client computer 200A via a communication link through the communication interface 102. The behavior editing mechanism 114 could use to edit the behavior sequence 106B which is recorded by the user and comprises the identification data of the object, the relating data of the behavior, and the time of the behavior being triggered. The behavior editing mechanism 114 also can be used to edit a triggered history of an object-behavior. To play the triggered history of the object-behavior would get the effect the user wanted. The behavior sequence 106B being edited can be save in the client computer 200A or upload to the website system 100 via a communication link through the communication interface 102. If the behavior sequence 106B saves in the client computer 200A, the behavior playing mechanism 108 could play the behavior sequence by directly accessing the edited behavior sequence 106B. If the behavior sequence needs to upload to the website system 100, the user could use the “Remote Data Service (RDS)” in the “Internet Explorer (a kind of web browser)” to upload the behavior sequence 106B to the website system 100 as alphabetic string.

In another embodiment, the object-behavior is a method and the digital content further comprises an specific event. If the user drives the method, then would further trigger the event. In this embodiment, the website system 100 of the present invention also comprises a behavior recording mechanism 116. The behavior recording mechanism 116 is downloaded to a client computer 200A via a communication link through the communication interface 102. The behavior recording mechanism 116 can record the behavior sequence 106B of the event being triggered. The behavior sequence 106B at least comprises the identification data of the object, the name of the method, and the time of the method being triggered. The process of recording the behavior sequence 106B is described as following: (use the web-object as an example)

The identification data of the object: During the process of triggering the specific event, using the following source code to acquire the identification data of the object:

document.event.srcElement.id

The name of the method: During the process of triggering the specific event, the client computer can acquire the name of the method. For example, use the source code “document.event.Type”, if the back report is “click”, then the name of the method is “click”.

The time of the method being triggered: configuring a counter would easily acquire the time of the method being triggered.

The behavior sequence 106B being recorded can be save in the client computer 200A or upload to the website system 100 via a communication link through the communication interface 102. If the behavior sequence 106B saves in the client computer 200A, the behavior playing mechanism 108 could play the behavior sequence by directly accessing the edited behavior sequence 106B. If the behavior sequence needs to upload to the website system 100, the user could use the “Remote Data Service (RDS)” in the “Internet Explorer (a kind of web browser)” to upload the behavior sequence 106B to the website system 100 as alphabetic string.

In another embodiment, the object-behavior is a property and the digital content further comprises an event. If the user triggers to change the property value, then would further trigger the event. In this embodiment, the website system 100 of the present invention also comprises a behavior recording mechanism 116. The behavior recording mechanism 116 is downloaded to a client computer 200A via a communication link through the communication interface 102. The behavior recording mechanism 116 can record the behavior sequence 106B of the event being triggered. The behavior sequence 106B at least comprises the identification data of the object, the name of the property/the change value of the property, and the time of the property being changed. The process of recording the behavior sequence 106B is described as following: (use the web-object as an example)

The identification data of the object: During the process of triggering the specific event, using the following source code to acquire the identification data of the object:

document.event.srcElement.id

The name of the property: During the process of triggering the specific event, the client computer can acquire the name of the property. For example, use the source code “document.event.Type”, if the back report is “change”, then the name of the property is “value”.

The change value of the property: During the process of triggering the specific event, the client computer can acquire the name of the property. For example, if the “onchange” event is triggered, then the change value of the property is the value in the mean time.

The time of the property being changed: configuring a counter would easily acquire the time of the property being changed.

The behavior sequence 106B being recorded can be save in the client computer 200A or upload to the website system 100 via a communication link through the communication interface 102. If the behavior sequence 106B saves in the client computer 200A, the behavior playing mechanism 108 could play the behavior sequence by directly accessing the edited behavior sequence 106B. If the behavior sequence needs to upload to the website system 100, the user could use the “Remote Data Service (RDS)” in the “Internet Explorer (a kind of web browser)” to upload the behavior sequence 106B to the website system 100 as alphabetic string.

In another embodiment, the object-behavior is an event. In this embodiment, the website system 100 of the present invention also comprises a behavior recording mechanism 1116. The behavior recording mechanism 116 is downloaded to a client computer 200A via a communication link through the communication interface 102. The behavior recording mechanism 116 can record the behavior sequence 106B of the event being triggered. The behavior sequence 106B at least comprises the identification data of the object, the name of the event, and the time of the event being trigger. The process of recording the behavior sequence 106B is described as following: (use the web-object as an example)

The identification data of the object: During the process of triggering the specific event, using the following source code to acquire the identification data of the object:

document.event.srcElement.id

The name of the event: During the process of triggering the specific event, the client computer can acquire the name of the event. For example, use the source code “document.event.Type”, if the back report is “mouseover”, then the name of the event is “onmouseover”.

The time of the event being triggered: configuring a counter would easily acquire the time of the event being triggered.

The behavior sequence 106B being recorded can be save in the client computer 200A or upload to the website system 100 via a communication link through the communication interface 102. If the behavior sequence 106B saves in the client computer 200A, the behavior playing mechanism 108 could play the behavior sequence by directly accessing the edited behavior sequence 106B. If the behavior sequence needs to upload to the website system 100, the user could use the “Remote Data Service (RDS)” in the “Internet Explorer (a kind of web browser)” to upload the behavior sequence 106B to the website system 100 as alphabetic string.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A method to manipulating a digital content which comprises a plurality of object-behaviors, the method at least comprising steps of:
1) providing a behavior sequence which is an order of the object-behaviors being triggered; and
2) triggering the object-behaviors in a proper order based on the behavior sequence.

2. The method of claim 1, wherein the behavior sequence comprises a plurality of information, each information comprises an identification data and an activating time of each object-behavior.

3. The method of claim 1, wherein the behavior is selected at least one from a group consisting of an event, a method and a property.

4. The method of claim 1, further comprising the following steps:
1) stopping trigger the object-behaviors during implementing the behavior sequence; and
2) triggering a specific object-behavior of the digital content by a input device.

5. The method of claim 4, further comprising the following steps:
1) implementing the specific object-behavior and canceling implementing the behavior sequence.

6. The method of claim 1, further comprising the following steps:
1) providing a visible indicating object to indicate the object-behavior being triggered at time during triggering the object-behaviors in a proper order.

7. The method of claim 1, further comprising a voice data relating to the object-behaviors, the method further comprising:
1) playing the voice data during triggering the object-behaviors in a proper order.

8. The method of claim 1, further comprising the following steps:
1) editing the behavior sequence.

9. The method of claim 1, further comprising the following steps:
1) recording the behavior sequence.

10. A system for manipulating a digital content which comprises a plurality of object-behaviors, the system at least comprising:
1) a memory, for storing the digital content and a behavior sequence which is an order of the object-behaviors being triggered; and
2) a center process unit, for implementing a behavior playing mechanism to trigger the object-behaviors in a proper order based on the behavior sequence.

11. The system of claim 10, wherein the behavior is selected at least one from a group consisting of an event, a method and a property.

12. The system of claim 10, further comprising an input device for stopping trigger the object-behaviors during implementing the behavior sequence; and triggering a specific object-behavior of the digital content.

13. The system of claim 12, wherein the center process unit further implements the specific object-behavior and cancels implementing the behavior sequence.

14. The system of claim 10, further comprising a visible indicating object to indicate the object-behavior being triggered at time during the center process unit triggering the object-behaviors in a proper order.

15. The system of claim 10, wherein the memory further stores a voice data relating to the object-behaviors, and the center process unit further plays the voice data during triggering the object-behaviors in a proper order.

16. The system of claim 10, further comprising an input device, the center process unit further implementing a behavior editing mechanism to edit the behavior sequence by using the input device.

17. The system of claim 10, wherein the center process unit further implementing a behavior recording mechanism to record the behavior sequence.

18. The system of claim 10, wherein the behavior sequence comprises a plurality of information, each information comprises an identification data and an activating time of each object-behavior.

19. A website system for manipulating a digital content in a client computer, the digital content comprising a plurality of object-behaviors, the website system at least comprising:
1) a communication interface for setting up a communication link with the client computer;
2) a memory, for storing the digital content and a behavior sequence which is an order of the object-behaviors being triggered, the digital content and the behavior sequence downloading to the client computer via the communication link through the communication interface; and
3) a behavior playing mechanism which is downloaded to the client computer via the communication link through the communication interface, for triggering the object-behaviors in a proper order based on the behavior sequence.

20. The website system of claim 19, wherein the behavior is selected at least one from a group consisting of an event, a method and a property.

21. The website system of claim 19, wherein the client computer further comprises an input device for stopping trigger the object-behaviors during implementing the behavior sequence, and for triggering a specific object-behavior of the digital content.

22. The website system of claim 21, wherein when implements the specific object-behavior, implementing the behavior sequence being canceled.

23. The website system of claim 19, further comprising a visible indicating object which is downloaded to the client computer via the communication link through the communication interface, for indicating the object-behavior being triggered at time during triggering the object-behaviors in a proper order.

24. The website system of claim 19, further comprising a voice playing mechanism which is downloaded to the client computer via the communication link through the communication interface, wherein the memory further stores a voice data relating to the object-behaviors, the voice data downloading to the client computer via the communication link through the communication interface, and the voice playing mechanism further plays the voice data during triggering the object-behaviors in a proper order.

25. The website system of claim 19, further comprising a behavior editing mechanism which is downloaded to the client computer via the communication link through the communication interface, for editing the behavior sequence.

26. The website system of claim 19, further comprising a behavior recording mechanism which is downloaded to the client computer via the communication link through the communication interface, for recording the behavior sequence.

27. The website system of claim 19, wherein the behavior sequence comprises a plurality of information, each information comprises an identification data and an activating time of each object-behavior.
